(19) United States
(12) Patent Application Publication
(10) Pub. No.: US 2009/0273229 A1
(43) Pub. Date: Nov. 5, 2009

(54) DEVICE AND METHOD FOR BRAKE PRESSURE REGULATION

(76) Inventors: Andreas KAESSMANN, Ditzingen (DE); Michael BUNK, Hampton (AU)

Correspondence Address: KENYON & KENYON LLP, ONE BROADWAY, NEW YORK, NY, 10004, US

(21) Appl. No.: 12/433,463

(22) Filed: Apr. 30, 2009

(30) Foreign Application Priority Data
Apr. 30, 2008 (DE) 102008001504.0

(51) Int. Cl. B60T 13/66

(52) U.S. Cl. 303/115.4

(57) ABSTRACT

The present invention relates to a braking force regulating system for a vehicle, including at least one discharge valve assigned to a wheel brake cylinder. The discharge valve is a constantly adjustable valve.

### BACKGROUND INFORMATION

Electronic stability regulating systems, such as ABS or ESP systems will increasingly become standard features in motor vehicles in the future. One of the basic requirements on a regulating system is the prevention of blocking wheels by the ABS function. This ensures the steerability of the vehicle, increases the stability of the vehicle by an increase in lateral guidance forces, and in addition makes possible a reduction in braking distance. The essential requirement on the hydraulics of the ABS/ESP system is, in this case, to implement a wheel pressure modulation, so as to control the slip of the wheels.

At the beginning of an ABS regulation, the inlet valves at the wheels demonstrating a large slip are closed, to prevent an additional pressure buildup. If a pressure limitation by itself is insufficient, the pressure is reduced via the discharge valves (AV), in order to achieve the running of the wheels again, that is, to reduce the slip. In this connection, the discharge valves are executed as closed control valves having no current.

Depending on the elasticity of the installed braking system, different reductions in pressure occur, which have to be adjusted via throttling of the discharge valves, in a manner that is specific to the project. In addition, the superposed driving dynamics controller has to be adjusted to these pressure reduction dynamics. This results in a great variety of variants.

Furthermore, the activation of the discharge valves characterized as control valves leads to audible switching noises and, in connection with a running return pump, to perceptible brake pedal modulations. These statements apply not only to the ABS function represented in exemplary fashion, but for all driving dynamics functions that depend on wheel brake pressure reduction that is individual to each wheel.

A method is described in German Patent No. DE 102 32 363 for ascertaining a pressure difference at a valve of a brake circuit, in which
a control signal is applied to the valve that is configured in such a way that abrupt changes in the braking pressure are suppressed, and
in which, from a knowledge of the control signal, the hydraulic pressure difference dropping off at the valve is ascertained.

### SUMMARY OF THE INVENTION

The present invention relates to a braking force regulating system for a vehicle. It includes at least one discharge valve associated with a wheel brake cylinder, the discharge valve being a constantly adjustable valve. Audible switching noises are eliminated thereby. Because of a steadier wheel pressure curve, a more constant volume flow also takes place, as a result, between the wheel brake cylinder and the storage chamber, whereby brake pedal modulations are able to be reduced to a minimum.

One advantageous embodiment of the present invention is characterized by the fact that the discharge valve is a magnetic valve. In modern passenger cars, magnetic valves are normally used.

One advantageous embodiment of the present invention is characterized by the fact that the discharge valve is a linear magnetic valve. This makes possible a precise adjustment of the valve lift.

Another advantageous embodiment of the present invention is characterized by the fact that the discharge valve is a pressure regulating valve. This makes possible a more precise adjustment of the pressure difference dropping off at the valve.

Yet another advantageous embodiment of the present invention is characterized by the fact that the braking force regulating system is an antilock system or a driving dynamics regulating system.

Moreover, the present invention includes a method for braking force regulation in a vehicle, a discharge valve being activated in at least one wheel brake cylinder for pressure reduction. The discharge valve is a steadily adjustable valve, in this context.

The advantageous embodiments of the device according to the present invention also translate into advantageous embodiments of the method according to the present invention, and vice versa.

### BRIEF DESCRIPTION OF THE DRAWINGS

FIG. 1 shows the braking system according to the present invention.

### DETAILED DESCRIPTION

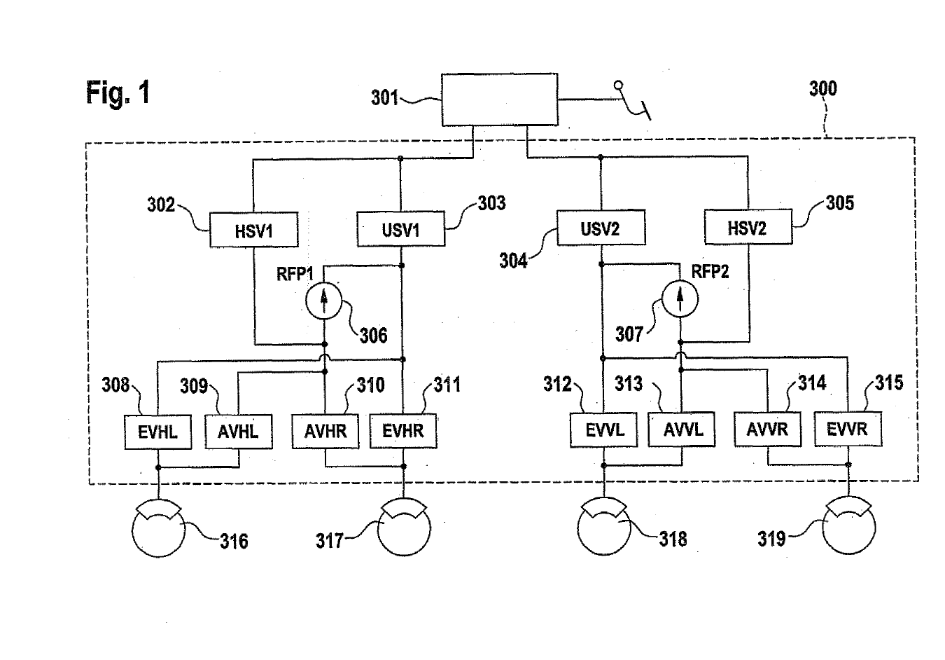

FIG. 1 shows schematically the braking system of a vehicle equipped with a driving dynamics control system. This may include an ABS functionality. In this context, all parts that are not important to the understanding of it are omitted. A braking system is discussed, for example, that has two brake circuits: Brake circuit 1 is the left branch in FIG. 1 (it is also denoted as floating circuit), and the right branch is brake circuit 2 (which is also denoted as linkage circuit). In this context, brake circuit 1 extends over the rear wheels and brake circuit 2 extends over the front wheels. This subdivision is also denoted as II-subdivision. Of course, other subdivisions are also conceivable.

Before we go into the processes in the braking system, we first briefly introduce the individual blocks:

300: hydraulic brake pressure control device

301: main brake cylinder

302: HSV1 (=high pressure switching valve of brake circuit 1)

303: USV1 (=switchover valve of brake circuit 1)

306: RFP1 (=return pump of brake circuit 1)

308: EVHL (=inlet valve rear left, i.e. at the brake of the left rear wheel)

309: AVHL (=discharge valve rear left)

311: EVHR (=inlet valve rear right)

310: AVHR (=discharge valve rear right)

316: wheel brake of left rear wheel

317: wheel brake of right rear wheel

305: HSV2 (=high pressure switching valve of brake circuit 2)

304: USV2 (=switchover valve of brake circuit 2)

307: RFP2 (=return pump of brake circuit 2)

312: EVVL (=inlet valve front left)

313: AVVL (=discharge valve front left)

315: EVVR (=inlet valve front right)

314: AVVR (=discharge valve front right)

318: wheel brake of left front wheel

319: wheel brake of right front wheel

The two return pumps are driven by a common motor, i.e. they are put in operation in parallel.

From main brake cylinder 301, two lines go to brake pressure control device 300. Inside the latter, a branching takes place to high pressure switching valves 302 and 305, and to switchover valves 303 and 304. High pressure switching valve 302 is connected to discharge valves 309 and 310 as well as the suction side of return pump 306. Switchover valve 303 is connected to inlet valves 308 and 311 as well as to the delivery side of return pump 306. The output side of inlet valve 308 and the input side of discharge valve 309 are connected to wheel brake 316, and, in the same way, inlet valve 311 and discharge valve 310 are connected to wheel brake 317.

High pressure switching valve 305 is connected to discharge valves 313 and 314 as well as to the suction side of return pump 307. Switchover valve 304 is connected to inlet valves 312 and 315 as well as to the delivery side of return pump 307. The output side of inlet valve 312 and the input side of discharge valve 313 are connected to wheel brake 318, and, in the same way, inlet valve 315 and discharge valve 314 are connected to wheel brake 319.

Return pump 306 lies between switchover valve 303 (delivery side) and discharge valves 309 and 310 (suction side), and return pump 307 lies between switchover valve 304 (delivery side) and discharge valves 313 and 314 (suction side).

An essence of the present invention is the development of at least one of the four discharge valves 309, 310, 313 and 314 of an ABS/ESP system as a constantly adjustable valve and its use for driving dynamic functions. There is consequently no longer any necessity of providing a project-specific throttling of the valves. In addition, the comfort of the system is able to be improved substantially.

By an improved activation of the discharge valves, perhaps using an LMV control or a Δp control, almost any pressure stages are able to be implemented without additional throttling of the valves. In the case of an LMV control (LMV=linear magnetic valve) various valve lifts are set via which a variable throttling is able to be implemented, as a function of the control current, in this context. Using the Δp control, the desired pressure stage or a desired pressure drop is set directly, using the control current. In this case too, one may do totally without a project-specific throttling of the discharge valves. The basis for both control types is the stability of the valves over the entire pressure range and flow-through range.

As a result, this makes possible not only a saving in valve throttling. By the specific control of the valves, substantially smaller pressure decreases may be set. Audible switching noises are eliminated thereby. Because of a steadier wheel pressure curve, a constant volume flow also takes place, as a result, between wheel brake cylinder and storage chamber, whereby brake pedal modulations are able to be reduced to a minimum.

Cases of application are, for example, ABS braking at low coefficient of friction, at which, as a rule, little environmental noise is present, and that being the case, switching noises of the discharge valves are the more clearly perceptible. Additional applications are partial braking during straight-ahead driving and in curves, in which the pressure of individual wheels is modulated, i.e. influenced, using electronic braking force distribution. Since, as a function of the vehicle, this already takes place at low pressure values, masking environmental noises such as the wind at driving speed or the squeaking of tires is missing. When a pressure reduction takes place, the switching noises of a switching valve are audible inside the vehicle. By using a constantly adjustable valve, having the ability of implementing almost any small pressure reductions, the noise development for this function may be almost completely suppressed.

What is claimed is:

1. A braking force regulating system for a vehicle, comprising:
at least one discharge valve assigned to a wheel brake cylinder, the discharge valve being a constantly adjustable valve.

2. The braking force regulating system according to claim 1, wherein the discharge valve is a magnetic valve.

3. The braking force regulating system according to claim 1, wherein the discharge valve is a linear magnetic valve.

4. The braking force regulating system according to claim 1, wherein the discharge valve is a pressure regulating valve.

5. The braking force regulating system according to claim 1, wherein the braking force regulating system is an antilock system or a driving dynamics regulating system.

6. A method for regulating a braking force in a vehicle, the method comprising:
activating a discharge valve for reducing a pressure in at least one wheel brake cylinder, the discharge valve being a constantly adjustable valve.
